(19) United States
(12) Patent Application Publication
(10) Pub. No.: US 2006/0036527 A1
(43) Pub. Date: Feb. 16, 2006

(54) Regulatory data uniform submission component

(76) Inventors: Paul Tinnirello, Oldwick, NJ (US); Arthur Snyder III, Oldwick, NJ (US)

Correspondence Address: MORRISON & FOERSTER LLP, 1650 TYSONS BOULEVARD, SUITE 300, MCLEAN, VA, 22102, US

(21) Appl. No.: 11/203,414

(22) Filed: Aug. 15, 2005

Related U.S. Application Data
(60) Provisional application No. 60/601,635, filed on Aug. 16, 2004.

(51) Int. Cl. G06Q 40/00

(52) U.S. Cl. 705/35; 705/4

(57) ABSTRACT

The invention relates to a system and method for collection, analysis, and submission of data for use in financial regulatory compliance in the insurance industry. In a preferred embodiment, the invention integrates an independently developed, standardized financial statement for collection of data by an insurance company, analyzes the collected data for compliance with specifications of a regulatory authority, and submits the data electronically and by other means to the regulatory authority. The financial statement provides detail on each insurer's business and investment risks, as well as information on insurance claims and reserves. The financial statement is one of several elements used by regulatory agencies and insurance-industry services providers to assess the financial strength of an insurance company. This assessment provides a reliable, objective means of indicating the financial strength and performance of insurance companies.

### FIELD OF THE INVENTION

The invention relates to a software system for collecting, analyzing, and submitting financial data by insurance and other companies that collect and submit regulatory and similar data electronically. The system determines whether the data is prepared in accordance with accepted standards, such as those of the National Association of Insurance Commissioners (NAIC), state insurance regulatory agencies, and/or an independent insurance-industry services provider, such as the A.M. Best Company. The invention performs numerous compliance and consistency checks to ensure that required input maintains data integrity, and submits the data through electronic means to meet the insurance company's regulatory filing criteria for the purposes of financial analysis and for use within the business processes of the insurance-industry services provider.

### BACKGROUND OF THE INVENTION

Each year, most insurance companies writing business in the United States, whether or not based in the United States, are required by the National Association of Insurance Commissioners (NAIC) to complete standardized quarterly and annual statements of their financial condition. The NAIC publishes detailed and extensive regulations for the completion and filing of these statements electronically.

Independent insurance-industry services providers, such as the A.M. Best Company (AMB), develop statement filing software each year in accordance with the NAIC conventions and under agreement with the NAIC. This software is used by the insurance industry to collect financial data, ensure its consistency within NAIC specifications, print copies of the statement in a variety of methods, and submit the financial information to the NAIC, the A.M. Best Company, state insurance regulatory agencies, and other insurance-industry services providers.

Currently, each statement filing software provider independently interprets and implements the NAIC conventions for embodiment in the provider's software. According to a best understanding of the intent of the NAIC specifications, each provider develops a self-contained, comprehensive application comprising the full range of requirements. The NAIC does not specify how the provider should design his software, only that the specifications must be correctly implemented within the software design. This approach to statement filing software design inherently contains subjectivity and generally produces variation among the providers with respect to the statement-data collection, analysis, and submission components.

A more reliable method is to separate the statement-data collection components from the analysis and submission components, replacing the traditional composite statement filing software. Each provider individually designs the statement-data collection components only, including entry interfaces, associated preliminary verification, and other appropriate utility functionality, while a discrete application encapsulates the analysis and submission requirements of the NAIC. The analysis and submission application is capable of integrating the statement-data collection components of each provider application and then processing the resulting data, eliminating the analysis and submission variability of the current approach. This improved organization produces more consistent financial data submissions for the benefit of the insurance industry, including the NAIC, A.M. Best Company, state regulatory agencies, and commercial printing services providers and other insurance-industry services providers.

For purposes of the present disclosure, the use of statement filing software, comprising statement-data collection components and analysis and submission components, will be described by way of example, using the A.M. Best Company's procedures to fulfill NAIC requirements and for use within its own business processes. Those skilled in the art will readily recognize that the disclosed software system can be adapted for use by most any independent insurance-industry, banking-industry, or financial-industry services provider, or independent software provider, to fulfill the statement filing requirements of most any domestic or foreign insurance-industry, banking-industry, or financial-industry regulatory agency.

The present invention, equivalently referenced as “Regulatory Data Uniform Submission Component™”, “RDUSC™”, “RDUSC™ application”, or “analysis and submission application”, is analysis and submission software that conforms to the NAIC and AMB conventions for electronic submission of statement data, and which can additionally integrate the statement-data collection components of independent provider software that conforms to NAIC conventions.

In the illustrative embodiment of the invention where data is being collected for submission to the NAIC, it is important to note that the NAIC conventions that must be embodied in statement filing software include:

Statement-Data Collection Components
NAIC statement forms which are organized into pages, exhibits, schedules, and supplements and reflect the insurance company's financial condition
Analysis and Submission Components
Type and format attributes of information to be reported on the forms, including numeric, percentage, factor, textual, date, graphical, precision, length, FEIN, CUSIP, and other attributes
Validation formulas that test the mathematical and logical interrelationship of amounts and text both within and among forms
Narrative explanations that clarify acceptable failures after validation testing
Specifications to convert the information reported on the forms into an electronic filing format
Printed output of the completed statement in Portable Document Format (PDF) or other electronic image format, or a hard copy version
Assembly of the component information into a Zip file format or other single electronically secured file format that may include compression and/or encryption
Submission of the Zip file or other single electronically secured file to the NAIC via the Internet, on diskette or CD/DVD-ROM, or by other electronic means

The major goals of the NAIC electronic filing conventions are increasing the quality of data that is submitted using statement filing software and achieving complete and timely submission of the data by each insurance company. Accordingly, it is desirable to have an electronic data collection and assembly system capable of providing these benefits for a wide range of regulatory data submission types.

### SUMMARY OF THE INVENTION

In an illustrative embodiment, the invention relates to a method for collecting, analyzing, and submitting data and, in a preferred embodiment, insurance industry-related data or insurance-industry financial data. A software-based financial statement permits data entry and collection at a user terminal, providing the information to be analyzed and submitted by the invention. The invention may be installed at the user terminal or present on a host server. Alternatively, components of the invention may be present in various locations and initialized or loaded as necessary.

The invention is an application that is capable of integrating the statement-data collection components of a software-based financial statement that conforms to the NAIC conventions, as described in step 330 of the FIG. 1. The statement-data collection software is developed by an independent insurance-industry services provider and is not an element of the invention. For example, statement-data collection software can include, but is not limited to, BestESP®, which is more fully described in commonly assigned, co-pending U.S. application Ser. No. 60/601,994, which is hereby incorporated by reference in its entirety. The analysis and submission capabilities of the invention will supersede the equivalent functions customarily performed by composite statement filing software, requiring only that the provider software permits collection of the statement data,

Additionally, the invention is capable of integrating a software-based supplemental rating and financial review questionnaire that conforms to AMB conventions, as described in step 810 of the FIG. 1. The questionnaire software is designed by an independent insurance-industry services provider and is not an element of the invention. For example, this software can include, but is not limited to, the Supplemental Rating and Financial Review Questionnaire (SRQ), which is more fully described in commonly assigned, utility U.S. application Ser. No. 11/060,572, which is hereby incorporated by reference in its entirety. The invention does not supersede any functions of the questionnaire software, but rather provides a capability to incorporate statement data and questionnaire data reciprocally.

The invention facilitates the analysis and submission of data, such as insurance industry-related data and/or insurance-industry financial data. For example, the first datum may be entered in response to a first query and a second datum may be entered in response to a second query using the statement-data collection software. The data are then analyzed using type and format attribute checking and formula validation.

To determine whether each datum is in compliance with electronic filing specification criteria, type and format attribute checking may occur. In order to check each datum individually, the invention should determine whether the datum conforms to certain electronic filing specifications. If the datum conforms to such specifications, as described in step 420 of the FIG. 1, then the datum is deemed “compliant”.

To determine whether the data entered by the user are reasonable, validation may occur. In order to validate the first and second datum, the invention should determine whether the data conform to certain rules. If the data conform to such rules, as described in step 420 of the FIG. 1, then the data are deemed “accurate”.

Compliance and accuracy should not be construed to mean the data entered by the user are correct or reflect true financial information, merely that the information requested by the statement-data collection software is consistent and within the parameters expected for such data. Only the end user can determine whether the data being entered are, in fact, correct or reflect true financial information. The present system, however, determines whether the first and second datum are in compliance by determining whether each datum conforms to an electronic filing specification, and further determines whether the first and second datum are accurate by determining if they have a relationship that conforms to a prescribed formula.

If the data are not in compliance, the invention may require the user to revise such data before continuing. The user may receive management reports or other notices indicating what data are not in accordance with the electronic filing specifications. Missing data or data of an incorrect type or format could be deemed not to be in compliance by the present system. The user must determine how the data can be modified for compliance.

If the data are not accurate, the invention may access a failure explanation file. The user may receive management reports or other notices indicating what data are not in accordance with the validation rules. Data that do not conform to the relationship prescribed by a validation formula could be deemed to be inaccurate by the present system. The user must determine which data can be modified for accuracy, and which inaccurate data require further clarification using the failure explanation file. In a preferred embodiment of the invention, a failure explanation file is created during the data validation process. In the event that entered data are not deemed accurate, an entry is added to the failure explanation file. If all of the data is determined to conform to the software program's guidelines, i.e., the data is accurate, the failure explanation file may be empty.

Once validation is complete and any failure messages have been rectified or explained, the data are assembled for submission. At least the first and second datum are assembled into component files. A single electronically secured file comprising the component files may also be created and then transferred to an insurance-industry regulatory agency or an independent insurance-industry provider of host services.

The present method for collecting, analyzing, and submitting data may require establishing communication between a provider of host services and a user computer via network connection, such as the Internet or other distributed network. Once connected, the host services provider may access a data file that includes information previously received from the user computer by the provider of host services. In the situation where the software is installed locally at the user computer, the host may determine whether the user computer has a most recent version of the program installed. If not, the host may execute a software program to update or install software on the user computer configured to collect, analyze, and submit data.

### BRIEF DESCRIPTION OF THE DRAWING FIGURES

FIG. 1 shows an illustrative flow chart of the software process of the present invention.

### DETAILED DESCRIPTION OF THE INVENTION

Overview of the Statement-Data Collection, Analysis and Submission Process

Both insurance companies and software providers are responsible for ensuring that the financial data is reported in the manner prescribed by the NAIC Electronic Filing Directive, which provides general guidelines and specific instructions for compatibility with the electronic filing requirements. With this document as a framework, the major steps in the statement filing process, comprised of statement-data collection components, and analysis and submission components, may be summarized as follows:

Statement-Data Collection Components

Insurance companies purchase the RDUSC and statement-data collection software from AMB and run setups on a workstation, network server, Web services server, or AMB host server. The statement-data collection software is integrated as a component of the RDUSC.
Company personnel assemble their financial information from a plurality of sources, including but not limited to, internal records, prior year AMB statement-data collection software, AMB corporate database servers, third-party software, and external parties, and in a plurality of formats, including but not limited to, paper, data files, graphics, word-processing documents, electronic spreadsheets, and PDF files or other electronic image files.
The financial information is incorporated by means of the statement-data collection software using a plurality of methods, including but not limited to, data entry onto forms, importing data files, word-processing documents, or electronic spreadsheets, scanning of paper documents, and copying externally created PDF files or other electronic image files.
The statement-data collection software performs a preliminary verification of the statement data for compliance with NAIC electronic filing requirements, and creates management reports of discrepancies.
The user revises data discrepancies as determined by the preliminary verification and runs the preliminary verification repetitively until all discrepancies have been brought into compliance.
The statement-data collection software provides the statement data in a plurality of file formats for analysis by the RDUSC.
   Analysis and Submission Components
Create a PDF file or other electronic image file, or a hard copy, of audit control management reports for each step of the analysis and submission process. Those skilled in the art will readily recognize that the “PDF” file format is a standard electronic image scheme used by personal computers running various operating systems.
Check the type and format attributes of each data element for compliance with electronic filing specification criteria.
Revise noncompliant data as reported by type and format checking and run type and format checking repetitively until all failed results have been eliminated.
Run validation formulas to test and report the reasonableness of the data both within and among forms.
Revise invalid data as determined by validations that report failed results and run validations repetitively until all failed results have been eliminated or all acceptable failed results have been identified.
Explain each acceptable failed validation result electronically in narrative form.
Record the collected and analyzed statement data in a file format defined by an electronic filing specification.
Create a set of PDF files or other electronic image files of the completed statement that conforms to an electronic filing specification.
Report the failed validation results and their failure explanations in file formats defined by an electronic filing specification.
Assemble the electronic filing component files, including the statement data file, statement PDF files or other electronic image files, validation results file, and validation failure explanation file, into a Zip file or other single electronically secured file that may include compression and/or encryption. Those skilled in the art will readily recognize that the “zip” file format is a standard compression scheme used by personal computers running various operating systems.
Submit the Zip file or other single electronically secured file to the NAIC and state insurance regulatory agencies, using filing Web sites, on diskette or CD/DVD-ROM, or by other electronic means.
Submit the component data files in a single electronically secured file or a plurality of electronically secured files to the A.M. Best Company, using a filing Web site, on diskette or CD/DVD-ROM, or by other electronic means.
Forward a separate copy of the statement PDF files or other electronic image files to a commercial printing services provider to reproduce a hard copy version of the completed statement if required.
Send an individualized hard copy of the completed statement to the NAIC, the A.M. Best Company, state of domicile insurance regulatory agency, and other state insurance regulatory agencies and interested parties as necessary.
   Supplemental Rating and Financial Review Questionnaire (SRQ) Extension

Each year, domestic, Canadian, and international insurance companies, cooperating with independent insurance-industry services providers such as the A.M. Best Company (AMB), complete a standardized supplemental rating and financial review questionnaire (SRQ). The SRQ provides detail on each insurer's business and investment risks, as well as information on insurance claims and reserves. The SRQ is one of several elements used by AMB to assign a Best's Financial Strength Rating to the insurance company, a rating that is well-known to those familiar with the insurance industry. This rating is recognized throughout the insurance industry as a reliable, objective means of indicating the financial strength and performance of insurance companies.

The SRQ requests information that supplements and/or complements the content and scope of the statutory filing required by the National Association of Insurance Commissioners (NAIC) for domestic companies, Office of the Superintendent of Financial Institutions (OSFI) for Canadian companies, and the corresponding insurance-industry regulatory authorities for international companies. Additionally, the SRQ information may be used in conjunction with the U.S. Securities and Exchange Commission filings of insurance-industry financial data. AMB publishes detailed and extensive instructions for the completion and filing of these questionnaires electronically.

The A.M. Best Company develops questionnaire filing software each year in accordance with its proprietary conventions. This software is used by the insurance industry to complete supplementary financial data, ensure its consistency within AMB specifications, and submit the financial information to the A.M. Best Company.

The AMB conventions that are embodied in the software include:
AMB questionnaire forms which are organized into interrogatories, tables, and descriptive information and reflect supplementary information about the insurance company's financial condition
Type and format attributes of information to be reported on the forms, including numeric, percentage, factor, textual, date, graphical, precision, length, and other attributes
Crosscheck formulas that test the mathematical and logical interrelationships of amounts and text both within and among forms
Specifications to convert the information reported on the forms into an electronic filing format
Printed output of the completed questionnaire and audit control management reports in Portable Document Format (PDF) or other electronic image format, or a hard copy version
Assembly of the component information into a single electronically secured file format that may include compression and/or encryption
Submission of the single electronically secured file to AMB via the Internet, on diskette or CD/DVD-ROM, or by other electronic means

The major goals of the AMB electronic filing conventions are increasing the quality of data that is submitted using the SRQ software and achieving complete and timely submission of the data by each insurance company.

The SRQ is an extension application that can work in conjunction with the invention, or alternatively may operate as a stand-alone application on any system where the invention is not available, or where the user does not wish to deploy the SRQ as an extension of the invention. This aspect of the invention is more fully described in commonly assigned, co-pending application Ser. No. 60/545,132, filed on Feb. 17, 2005, which is hereby incorporated by reference in its entirety.

The RDUSC Concept

The Regulatory Data Uniform Submission Component (RDUSC) is an application that is capable of integrating the statement-data collection components of a software-based financial statement that conforms to the NAIC, or other, conventions. In one embodiment, the RDUSC is capable of integrating a software-based supplemental rating and financial review questionnaire that conforms to AMB conventions. The RDUSC setup can be run on a user workstation, network server, Web services server, or AMB host server, and updated periodically and as necessary via a Software Support Center. A Web based setup is the preferable distribution method, but alternatives of CD/DVD-ROM, e-mail, or other electronic means will be available for those users without Internet capability.

Access to data may include both single user and multi-user methods, employing a data locking scheme that is independent of the inherent data locking mechanisms of a database, operating system, or network protocol. In the single user method, the data may only be available to one user at a time and is locked in its entirety. Another user may not gain access to any data until the current user exits from the RDUSC application and releases all of the data locks. This method may be useful, for example, in a company where a limited number of users are authorized to run the RDUSC, or where there is restricted access to the data.

By contrast, in the multi-user method, two or more users on a network may share access to the same data by running multiple copies of the RDUSC application. A single data element is locked by the first user who requests access to that element, and the element may be accessed by any other user only after the first user relinquishes the lock. All other unlocked data elements are available to any other user in a similar manner. The scope of data elements that may be locked by a user can vary considerably, including, but not limited to, a single cell of collected data, all collected data for a form, all collected data for all forms, and various input and output analysis and submission files. The data locking scheme can ensure data integrity by preventing concurrent modification of a data element by multiple users. This method may be useful, for example, in a company where a workgroup of users shares the responsibility of running the RDUSC, or where there is broad access to the data.

The RDUSC may include processes to import data files from external financial software applications, and procedures to incorporate external electronic and paper documents as data; audit control management reports, data validation and verification, and failure explanation procedures; data conversion with compression, PDF or other electronic image creation, and hard copy printing capabilities; type and format checking of data attributes; assembly of component data files into a Zip file or other single electronically secured file that may include compression and/or encryption, electronic media creation, and submission of the single electronically secured file via the Internet, on diskette or CD/DVD-ROM, or by other electronic means; exporting component data for use in external software applications; and availability of AMB host servers to incorporate previously filed data, create insurance-industry analytical executive reports, and access on-line insurance-industry resources.

Insurance companies will utilize statement-data collection software to assemble their financial data from a plurality of sources and file formats. The statement-data collection software components, which may include entry interfaces, associated preliminary verification, and other appropriate utility functionality, are integrated with the RDUSC when the RDUSC setup is run. Once the preliminary verification is finished, the statement-data collection software may provide the statement data in a plurality of file formats for analysis by the RDUSC. The RDUSC can ensure the consistency of the data within NAIC specifications, and create, assemble, and submit the electronic submission component files required by the NAIC, AMB, state insurance regulatory agencies, and commercial printing services providers or other insurance-industry services providers, in a standard and consistent process.

User interfaces for the various aspects of the analysis and submission are desirably kept to a minimum in order to automate the RDUSC process as fully as possible. A user profile and submission checklist will specify the conditions for analysis and submission to run the processes in the proper sequence and eliminate unnecessary user intervention. These conditions can include statement type, filing type, and filing deadline; validation results selection and failure explanation creation; component data files to be submitted; Internet, diskette, CD/DVD-ROM, or other electronic means filing preference; and numerous additional options. Audit control reports may also be generated as a PDF file or other electronic image file, or as a hard copy, to manage each step of the analysis and submission process.

Mechanisms will be provided to ensure that all components of the analysis and submission have been created and assembled by the RDUSC, and not by any external resources that produce electronic image files and electronically secured files with compression and/or encryption. Indicators will be set at various stages, which can be interrogated by software systems at the NAIC, AMB, state insurance regulatory agencies, and commercial printing services providers and other insurance-industry services providers, verifying that the sole source of the analysis and submission is the RDUSC application. The electronic filing could be rejected if these conditions have not been met.

The RDUSC Architecture

The RDUSC architecture employs an innovative model that defines the elements and processes as a set of distributed and decentralized services that are reusable by multiple applications. These services may exist anywhere on the network to maximize utilization of the network's characteristics, their location is transparent and immaterial to the user, and they perform specific, discrete functions. This approach offers distinct advantages for ensuring data integrity and security, including verifying and restricting personnel access, creating backup archives, off-site or hot-site warehousing, and encryption. The user is relieved of much of the ongoing activity of data management, and can instead focus on the core business without the added responsibility of system administration.

Traditional software development physically deploys programs, files, and support components of an application in one place and typically expects the input and output data to be available in that same location. For example, an installer program may copy programs, databases, and support files to a designated root folder with sub-folders on a workstation or local network server, and the software may create new data files or incorporate data from external sources using another sub-folder under the same root folder on the same system. The user is required to understand this folder structure and features of the operating system to backup or restore files, retrieve information from a prior year, copy data files from a source location, or copy data files to a target location.

By contrast, the RDUSC architecture of decentralized services does not require physical deployment of programs, files, and support components of an application on a user workstation or local network server, but merely access to each service at its current host location. Furthermore, there is no requirement to locate programs, databases, and support files at any particular dedicated host or combination of hosts, only that those facilities be available when required. For example, the RDUSC setup can enable host services at AMB via the Internet to access collected data, incorporate previously filed data, check type and format attributes, run validation formulas, create the various electronic filing component files, transfer electronically secured files to a filing Web site, and perform backup operations, while allowing the user to store the collected data and component files, electronically secured files, and backup files on a workstation or network server. Alternatively, the user could request the RDUSC setup to enable selected services on company intranet or extranet servers with access to the Internet, while storing the collected data and component files, electronically secured files, and backup files on AMB servers. The user does not need to understand any folder or network structure or features of the operating system to backup or restore files, retrieve information from a prior year, copy data files from a source location, or copy collected-data files to a target location.

Maximum flexibility and distribution of services are available when the user is connected to the Internet, taking full advantage of the AMB host services in conjunction with the user facilities. In the absence of an Internet connection, the RDUSC setup can still enable the services architecture on an extranet, intranet, or peer-to-peer network, although with diminishing capabilities. Finally, running the RDUSC setup on a stand-alone workstation without Internet access will disable all services and install the RDUSC as a traditional application.

As an illustrative embodiment, the RDUSC architecture is divided into several broad categories, each containing related types of services, which may include, but are not limited to:
AMB Host—services include, but are not limited to, Setup, Software Support Center, Previously Filed Data, Data Submission Site, Executive Reports, On-line Insurance-Industry Resources
Collected-Data Completion—services include, but are not limited to, Statement-Data Collection Software Integration, SRQ Integration, External Data, Type and Format Checking, Validation, Failure Explanation, Audit Control Reports
Printing—services include, but are not limited to, Electronic Image Copy, Hard Copy
Filing Component—services include, but are not limited to, Statement Data File, Validation Results File, Failure Explanation File, Electronic Image File, Electronically Secured File
Submission—services include, but are not limited to, Filing Site Transfer, CD/DVD Creation, Diskette Creation
Data Export—services include, but are not limited to, NAIC Export, AMB Export, XML Export, XBRL Export, Electronic Spreadsheet Export
Security—services include, but are not limited to, Compression, Encryption, Authentication, Single User/Multi-User Data Access, Backup/Restore
   Advantages of the RDUSC Design

The RDUSC advantages for the insurance industry, including the NAIC, AMB, state insurance regulatory agencies, commercial printing services providers and other insurance-industry services providers, and insurance companies, are the following:
The RDUSC services approach creates a flexible, scalable architecture that utilizes workstations, network servers, Web services servers, and AMB host servers in a distributed environment and to maximum advantage.
The distributed services relieve the user of much of the ongoing activity of data management, and allow the user to instead focus on the core business without the added responsibility of system administration.
It provides a standardized procedure to analyze statement data, create the submission components, and deliver them to their destinations. This eliminates the separate interpretations inherent when each statement filing software provider individually implements the NAIC conventions, providing consistency to the industry.
It seeks to minimize the interaction between the user and the submission process by encapsulating all of the functionality in a series of automated steps. The user should be concerned primarily with collecting the data and filing it by the deadline with the NAIC, the A.M. Best Company, state insurance regulatory agencies, and commercial printing services providers and other insurance-industry services providers, and not the technical basis of analyzing and creating an NAIC electronic submission by running discrete processes.
The PDF or other electronic image technology implemented in the RDUSC produces efficiently compressed and organized files. Files that are consistently optimized for Internet viewing are available for analysis and printing more readily, and are less wasteful of communication bandwidth.
Concurrent filing of the NAIC component data and SRQ supplementary data at AMB results in more comprehensive and timely information, enhancing the accuracy of insurance industry ratings.
For users with Internet capability, timely software updates can be provided via the Software Support Center as an automatic service for a user workstation, network server, Web services server, or AMB host server, eliminating the need to manually install periodic and potentially outdated updates by CD/DVD-ROM, e-mail, or other electronic means. Variations in data submission arising from differing software versions can be minimized.
   Illustrative Overview of the RDUSC Model

In an illustrative embodiment, the RDUSC model is divided into several broad areas of functionality, as follows.
100 Series—RDUSC setup is run on a user workstation, network server, Web services server, or AMB host server, from a plurality of sources and independent statement-data collection software and the SRQ extension application are integrated.
200 Series—AMB host servers and other facilities at AMB provide services via the Internet.
300 Series—RDUSC optionally accesses previously filed data as available from AMB, and incorporates AMB data and other external data into collected data from a plurality of file formats. The user completes statement-data collection by means of the independent statement-data collection software, the software performs a preliminary verification of the statement data, and provides the statement data in a plurality of file formats for analysis by the RDUSC.
400 Series—RDUSC processes the statement data, provides audit control management reports, creates the electronic submission component files, assembles the submission in a plurality of methods for the NAIC, the A.M. Best Company, state insurance regulatory agencies, and commercial printing services providers and other insurance-industry services providers, and exports the component data in a plurality of file formats.
500 Series—User manually sends the single secured electronic submission file to the NAIC, state regulatory insurance agencies, and other insurance-industry services providers, if Internet access is not available, and additionally sends a hard copy of the completed statement to these entities and the A.M. Best Company by mail or other delivery service. User manually sends PDF files or other electronic image files of the completed statement separately to a commercial printing services provider, if Internet access is not available.
600 Series—RDUSC automatically transfers the single secured electronic submission file to the NAIC Web site, and transfers PDF files or other electronic image files of the completed statement to a commercial printing services provider Web site if the user has Internet access.
700 Series—RDUSC creates executive reports using the current component data and previously filed data as available from AMB, and accesses on-line insurance-industry resources at AMB.
800 Series—User completes current year data for the SRQ extension of the RDUSC and exports the questionnaire data in a plurality of file formats.
900 Series—RDUSC automatically transfers component data and SRQ data in a plurality of electronically secured file formats to an AMB Data Submission Site via the Internet, or the user manually sends the secured electronic data files on diskette or CD/DVD-ROM, or by other electronic means, to AMB if Internet access is not available. User imports component data into a plurality of external software applications.
   Description of RDUSC Flowchart

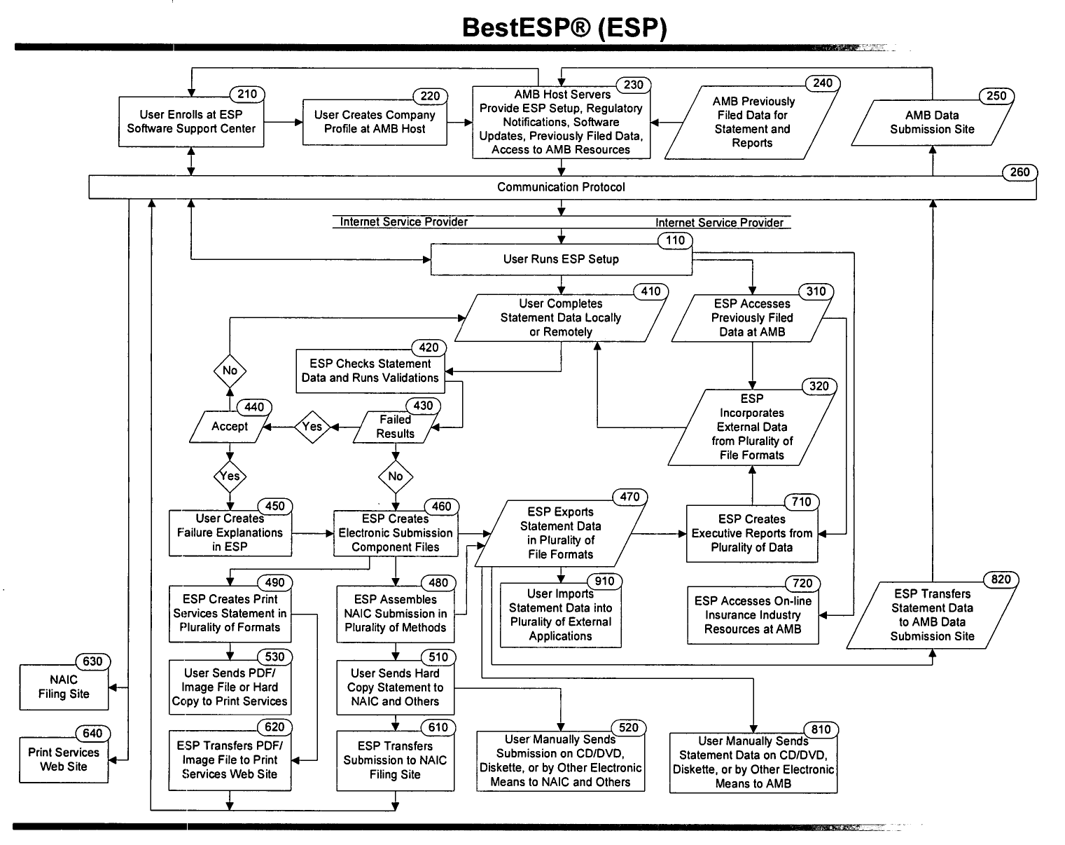

Following is a detailed description of the illustrative model embodied in the RDUSC flowchart, shown in FIG. 1:
110—The RDUSC software setup is run by the user on any combination of workstations, network servers, Web services servers, or AMB host servers. The statement-data collection software developed by an independent insurance-industry services provider, and optionally the SRQ extension application, are integrated as components of the RDUSC. The preferred setup method will be to run the Web based process from an AMB host server at (230) via Internet browser software that connects to the Software Support Center at (210). After completing the enrollment procedure at (210), the company profile at (220), and the RDUSC setup at (230), the AMB host services will be available. Ongoing communication between the user and the AMB host services will be provided via the Software Support Center. Alternative CD/DVD-ROM, e-mail, or other electronic setups will be available for users without Internet capability, but these would not provide access to the AMB host services. The RDUSC may be configured to transmit information over an open network such as the Internet, a peer-to-peer local area network such as Microsoft Networking, and intranet, extranet, or other wide area network, a mobile device such as Blackberry, or any combination, using communication protocols that can include, but are not limited to, TCP/IP, FTP, HTTP, and SSL.
210—The user enrolls at the RDUSC Software Support Center for online software support and other AMB host services. Enrollment involves establishing traditional mailing and electronic contact information, and creating an account number and security profile. The enrollment information will be used to provide ongoing Web based support for the RDUSC and the data analysis and submission process. The Software Support Center will be the portal by which the RDUSC communicates between the user and the AMB host services.
220—The user supplements (210) by additionally creating a company profile at an AMB host server. The profile will define a plurality of operating environments for the user, including, but not limited to, workstations, network servers, Web services servers, AMB host servers, communication facilities, types of host services, file locations, and other preferences. The types and frequency of e-mail broadcast notifications and automated software updates the user wishes to receive, and access to previously filed data, executive reports, and AMB on-line insurance-industry resources, will be customized. The profile will also control the transfer of data to an AMB Data Submission Site at (250), the NAIC filing site at (630), and a commercial printing services provider Web site at (640).
230—AMB host servers provide the Web based setup for the RDUSC, periodic regulatory notification by e-mail, automated software updates, previously filed data, analytical executive reporting, access to AMB on-line insurance-industry resources, and transfer acknowledgements for data received at (250). The type and frequency of these communications will be based upon the information provided at (210) and (220).
240—The RDUSC accesses the AMB corporate database servers to provide previously filed data at (310) for statement-data collection at (330), the executive reports created at (710), and SRQ completion at (810). The type of data available to the user is based upon the information provided in the company profile at (220).
250—An AMB Data Submission Site may comprise a plurality of AMB host servers that receive transfers of electronically secured component data files and SRQ data files from the RDUSC at (920), based upon the information provided at (220). Verification and acknowledgement of these transfers are sent to the user at (230).
260—Communication between the user and AMB host services is conducted via the Internet using protocols that can include, but are not limited to, TCP/IP, FTP, HTTP, and SSL. The user must make arrangements with an Internet Service Provider to install the appropriate communication capability, which may include, but is not limited to, dialup, DSL, cable, Ti, and WiFi.
310—The RDUSC accesses the AMB corporate database servers at (240) to provide previously filed data for statement-data collection at (330), the executive reports created at (710), and SRQ completion at (810). The type of data available to the user will be based upon the information provided in the company profile at (220).
320—The RDUSC incorporates external data into the collected data from a plurality of file formats. These file formats can include, but are not limited to, previous year statement-data collection software files, NAIC electronic submission component data files, AMB data file import specifications, AMB executive report data, SRQ data, PDF files or other electronic image files, electronically scanned paper documents, electronic spreadsheet files, and databases or other data structures incorporating XML, XBRL, or other mark-up or tagging languages. The external data may be retained in a plurality of original file formats or optionally converted to a common file format specified by the independent statement-data collection software.
330—The user completes statement-data collection by means of the independent statement-data collection software from a plurality of current year and previously filed sources. These sources can include, but are not limited to, manual entry from company records, external PDF files or other electronic image files, electronic scanning of paper documents, electronic spreadsheets, AMB corporate database servers at (310) and a plurality of external data at (320). The plurality of data files may reside on a user workstation, network server, Web services server, AMB host server, or any combination. The statement-data collection software performs a preliminary verification of the statement data for compliance with NAIC electronic filing requirements, and creates management reports of discrepancies. The user revises data discrepancies as determined by the preliminary verification and runs the preliminary verification repetitively until all discrepancies have been brought into compliance. The statement-data collection software provides the statement data in a plurality of file formats for analysis by the RDUSC. These file formats can include, but are not limited to, the native structure of the statement-data collection software data files, NAIC electronic submission component data files, AMB data file export specifications, PDF files or other electronic image files, and databases incorporating XML, XBRL, or other mark-up or tagging languages.
410—The RDUSC processes the statement data from a plurality of file formats provided in (320) and (330). The RDUSC checks the type and format attributes of each data element for compliance with electronic filing specification criteria at (420), runs validation formulas to test and report the reasonableness of the data both within and among forms at (420), and creates at (460) and assembles at (480) the necessary electronic submission component files. Audit control reports may also be generated as a PDF file or other electronic image file, or as a hard copy, to manage each step of the statement data analysis and submission process. The results that are reported may include, but are not limited to, incorporating external data, checking the type and format of data attributes, running validations, creating and assembling the electronic submission component files, or transferring electronically secured files to the NAIC, AMB, state insurance regulatory agencies, and commercial printing services providers and other insurance-industry services providers. The submitted data is available to the NAIC, AMB, state insurance regulatory agencies, and commercial printing services providers or other insurance-industry services providers, in a standard and consistent process.
420—The RDUSC checks the type and format attributes of each statement data element for compliance with NAIC electronic filing specification criteria. The type attributes can include, but are not limited to, numeric, percentage, factor, textual, date, and graphical, while the format attributes may include, but are not limited to, missing data, precision, length, FEIN, and CUSIP. The RDUSC runs the NAIC validation formulas to test and report the reasonableness within validation rules of the statement data, and additionally provides optional AMB validations that extend the scope of this data testing beyond the NAIC standards. AMB validations are included to enhance the RDUSC analysis capability only, and are not required for compliance with the electronic submission as prescribed by the NAIC Electronic Filing Submission Directive. A typical validation of statement data may comprise a large number of computations, each requiring the evaluation of many mathematical formulae, in order to ensure that the statement data conforms to expected guidelines. A large statement, for example, may require hundreds of thousands of calculations to validate. Validation formula characteristics may include, but are not limited to, single and multiple logical operators within each formula, individual or combination testing of inter-form and intra-form data, single or multiple testing steps within each formula, and dollar or percentage tolerances that define an allowable deviation from a target amount. Whenever electronic filing specification or validation formula revisions or enhancements for the current year are required, they may be accessed via the Software Support Center at (210) if the user is connected to the Internet, while users without Internet capability will receive a CD/DVD-ROM, e-mail, or other electronic update at appropriate intervals.
430—The RDUSC reports the results of checking the type and format attributes, and running the NAIC validations, and indicates whether any results have failed. The RDUSC reports the results of running the optional AMB validations and indicates whether any results do not meet AMB guidelines. Failed attribute checking results or failed NAIC validation results will require additional analysis by the user at (440), while an absence of failed results will allow the user to create the electronic submission component files at (460). AMB validation results that do not meet AMB guidelines may be analyzed optionally at (440), but these validation results will not preclude creating the electronic submission component files at (460).
440—The user must analyze each failed attribute checking result and each failed NAIC validation result for its validity, and optionally analyze each AMB validation result that does not meet AMB guidelines. The majority of failed NAIC results will be unacceptable, due primarily to improper or inconsistent statement data, which must be revised at (330). An individual data element is not permitted to deviate from the type and format attributes for that element and must always be revised for compliance with the electronic filing specification criteria. However, validation results may justifiably fail due to business exceptions, or because the NAIC validation formula needs revision. In these acceptable instances, the user may override the failure by creating an explanation at (450) for each failed NAIC validation result. AMB validation results that do not meet AMB guidelines, but which are acceptable, neither require nor permit an explanation at (450).
450—The RDUSC provides the ability for the user to create an electronic narrative explanation for any failed NAIC validation result that is identified as acceptable. The user can not create the electronic submission component files at (460) until all failed NAIC validation results have been explained in this manner. The user will perform (330) through (450) repetitively until all unacceptable failed NAIC validation results have been revised and all acceptable failed NAIC validation results have been explained. The user may optionally perform (330) through (440) repetitively until all AMB validation results that do not meet AMB guidelines, and which are unacceptable, have been revised, but an explanation for these validation results is neither required nor permitted at (450).
460—The RDUSC creates the component files required by the NAIC electronic submission conventions. The statement data will be recorded in a Statement Data Submission File and the completed statement will be printed in a set of Statement Data PDF Files. The failed NAIC validation results and their explanations will be reported in a Validation Results Submission File and Validation Failure Explanation Submission File, respectively.
470—The RDUSC exports the completed component data in a plurality of file formats with compression and/or encryption for use with executive reports at (710), SRQ completion at (810), copying the files to diskette or CD/DVD-ROM, or other electronic means, to send to AMB at (910), Internet transfer to an AMB Data Submission Site at (920), and import into a plurality of external applications at (930). These file formats can include, but are not limited to, Zip file or single electronically secured file, NAIC electronic submission component files, AMB data file export specifications, PDF files or other electronic image files, electronic spreadsheet files, and databases or other data structures incorporating XML, XBRL, or other mark-up or tagging languages. Various compression algorithms may be used for efficiency with different file types, and can include, but are not limited to, Zip for data, JPEG or GIF for images, PDF for documents, and MPEG or WAV for streaming media. Encryption may be accomplished using commercially available 128-bit or higher software, and additional security and authentication can include, but is not limited to, VeriSign, Thawte, or similar management services.
480—The RDUSC assembles the component files into a Zip file or other single electronically secured file with compression and/or encryption in a plurality of methods for submission to the NAIC, AMB, state insurance regulatory agencies, and other insurance-industry services providers. These methods can include, but are not limited to, storing the file on a user workstation, network server, Web services server, or AMB host server, for eventual Internet transfer to the NAIC filing site at (630) or an AMB Data Submission Site at (920), and copying the file to diskette or CD/DVD-ROM, or other electronic means, to send to the NAIC, state insurance regulatory agencies, or other insurance-industry services providers at (520) or AMB at (910). The RDUSC also prints a hard copy of the completed statement to be sent to the NAIC, AMB, state insurance regulatory agencies, or other insurance-industry services providers at (510).
490—The RDUSC creates a separate copy of the completed statement in a plurality of formats to be provided to a commercial printing services provider. These formats can include, but are not limited to, storing a PDF file or other electronic image file on a user workstation, network server, Web services server, or AMB host server, for eventual Internet transfer to a commercial printing services provider Web site at (640), and copying the PDF file or other electronic image file to diskette or CD/DVD-ROM, or other electronic means, or printing a hard copy, to send to a commercial printing services provider at (530).
510—The user sends a hard copy of the completed statement to the NAIC, AMB, state insurance regulatory agencies, or other insurance-industry services providers by mail or other delivery service.
520—The user sends the Zip file or other single electronically secured file on diskette or CD/DVD-ROM, or by other electronic means, to the NAIC, state insurance regulatory agencies, or other insurance-industry services providers, by mail or other delivery service. Sending the Zip file or other single electronically secured file by these methods supersedes transferring the file to the NAIC filing site at (630).
530—The user sends the completed statement as a PDF file or other electronic image file, on diskette or CD/DVD-ROM, or by other electronic means, or as a hard copy, to a commercial printing services provider by mail or other delivery service. Sending the completed statement by these methods supersedes transferring the statement to a commercial printing services provider Web site at (640).
610—The RDUSC connects to the NAIC filing site via the Internet, identifies and locates on a user workstation, network server, Web services server, or AMB host server, the required Zip file or other single electronically secured file to be submitted, and transfers the selection. Transferring the Zip file or other single electronically secured file by this method supersedes sending the file on diskette or CD/DVD-ROM, or by other electronic means, at (520).
620—The RDUSC connects to a commercial printing services provider Web site via the Internet, identifies and locates on a user workstation, network server, Web services server, or AMB host server, the required PDF file or other electronic image file to be printed, and transfers the selection. Transferring the PDF file or other electronic image file by this method supersedes sending the file on diskette or CD/DVD-ROM, or by other electronic means, at (530).
630—The NAIC filing site receives the Zip file or other single electronically secured file transferred by the RDUSC. Additional verification and acknowledgement may performed by the NAIC filing site.
640—A commercial printing services provider Web site receives the PDF file or other electronic image file transferred by the RDUSC. Additional verification and acknowledgement may be performed by the commercial printing services provider Web site.
710—The RDUSC creates executive reports from a plurality of data sources that are customized by the company profile at (220), which can include, but are not limited to, current year electronic submission component data, SRQ data, and previously filed information from AMB corporate database servers. These reports can include, but are not limited to, analysis by peer companies, groups of companies, or industry segments.
720—The RDUSC accesses on-line insurance industry resources at AMB. These resources can include, but are not limited to, daily, weekly, and monthly news publications, statistical studies, and rating methodology. The type of resources available to the user will be based upon the information provided in the company profile at (220).
810—The user completes the SRQ data from a plurality of current year and previously filed sources. The SRQ extension application is integrated with the RDUSC, and works in conjunction with the RDUSC to provide questionnaire data for the executive reports created at (710) and transfer the data to an AMB Data Submission Site at (920).
820—The RDUSC exports the completed SRQ data in a plurality of file formats with compression and/or encryption for use with statement-data collection at (330), executive reports at (720), copying the files to diskette or CD/DVD-ROM, or other electronic means, to send to AMB at (910), Internet transfer to an AMB Data Submission Site at (920), and import into a plurality of external applications at (930). These file formats can include, but are not limited to, single electronically secured file, AMB data file export specifications, PDF files or other electronic image files, electronic spreadsheet files, and databases or other data structures incorporating XML, XBRL, or other mark-up or tagging languages. Various compression algorithms may be used for efficiency with different file types, and can include, but are not limited to, Zip for data, JPEG or GIF for images, PDF for documents, and MPEG or WAV for streaming media. Encryption may be accomplished using commercially available 128-bit or higher software, and additional security and authentication can include, but is not limited to, VeriSign, Thawte, or similar management services.
910—The user sends the electronically secured component data files and SRQ data files on diskette or CD/DVD-ROM, or by other electronic means, to AMB by mail or other delivery service. Sending the electronically secured component data files and SRQ data files by these methods supersedes transferring the data files to an AMB Data Submission Site at (920).
920—The RDUSC connects to an AMB Data Submission Site via the Internet, identifies and locates on a user workstation, network server, Web services server, or AMB host server, the required electronically secured component data files and SRQ data files to be submitted, and transfers the selections. Transferring the electronically secured component data files and SRQ data files by this method supersedes sending the files on diskette or CD/DVD-ROM, or by other electronic means, at (910).
930—User imports component data and SRQ data into a plurality of external applications. These applications can include, but are not limited to, general ledger systems, electronic spreadsheets, tax preparation systems, and corporate databases.

The present disclosure relates to a preferred embodiment of the present invention and is applicable to a wide variety of uses within the insurance industry. For example, although insurance-industry financial data is used throughout the description, the invention may include the use of insurance-related data generally and not merely be limited to the embodiments described herein.

What is claimed:

1. A method for collecting data, comprising:
initializing a software-based insurance industry-related financial statement;
entering a first insurance industry-related datum in response to a first query;
entering a second insurance industry-related datum in response to a second query;
checking the type and format attributes of each datum;
determining whether each insurance industry-related datum is in compliance, wherein the compliance of each datum is determined by whether it conforms to electronic filing specification criteria;
validating the first and second insurance industry-related data;
determining whether the first and second insurance industry-related data are accurate, wherein the accuracy of the first and second insurance industry-related data is determined by whether the first and second insurance industry-related data have a relationship that conforms to a prescribed formula;
creating a failure explanation file and creating an entry in the failure explanation file if the first and second insurance industry-related data are not accurate;
assembling at least the first and second insurance industry-related data into component files;
creating an electronically secure data file comprising the component files;
transferring the data file to the originator of the financial statement.

2. The method of claim 1 wherein the software-based insurance industry-related financial statement is configured to be accessed via a user terminal.

3. The method of claim 2 wherein the user terminal communicates with a provider of host services via a distributed network.

4. The method of claim 3 comprising downloading software components to the user terminal from the provider of host services.

5. The method of claim 4 comprising enrolling a user on the provider of host services and providing software support to the user, the software support comprising product updates, product news, customized user-specific information, and combinations thereof.

6. The method of claim 1 wherein the secure data file is encrypted and/or compressed.

7. The method of claim 1 wherein the secure data file is transferred to the originator of the financial statement via a network connection.

8. The method of claim 5 comprising automatically transmitting product updates to the user terminal.

9. The method of claim 1 wherein the originator of the financial statement comprises at least one server for receiving at least one secure data file from at least one user terminal.

10. The method of claim 9 comprising transmitting a verification and/or acknowledgement from the originator to the user terminal when a secure data file is received by the originator.

11. The method of claim 1 wherein the insurance industry-related data comprises insurance data, financial data, data that is requested in response to a requirement of law or industry regulation, or combinations thereof.

12. A method for collecting insurance industry-related data, comprising:
establishing communication between a provider of host services and a user terminal via network connection;
accessing a data file including information previously received from the user terminal by the provider of host services;
determining whether the user terminal has a most recent version of a software program installed;
optionally executing a software program to update or install software on the user terminal configured to collect insurance industry-related data;
collecting more than one insurance industry-related datum;
determining whether each insurance industry-related datum entered into the software program is in compliance by checking the type and format attributes of each datum, wherein an insurance industry-related datum is considered to be in compliance when it conforms to electronic filing specification criteria;
determining whether the insurance industry-related data entered into the software program is accurate by validating at least one datum with at least one other datum, wherein insurance industry-related datum are considered to be accurate when they conform to a prescribed relationship;
creating a failure explanation file and creating an entry in the failure explanation file if the insurance industry-related data is not accurate, the entry comprising a failure explanation message;
assembling the insurance industry-related data into component files;
creating a data file comprising the component files;
transferring the data file to the originator of the financial statement.

13. The method of claim 12 wherein the data file is encrypted and/or compressed.

14. The method of claim 12 wherein the data file is forwarded to the originator of the financial statement on a CD-ROM, DVD, floppy diskette, hard disk drive, or tape cartridge.

15. The method of claim 12 wherein the data file is printed and forwarded to the originator of the financial statement.

16. The method of claim 12 wherein the data file is transferred to the originator server via the Internet.
